(19) United States
(12) Patent Application Publication
(10) Pub. No.: US 2011/0181499 A1
(43) Pub. Date: Jul. 28, 2011

(54) LIGHT EMISSION DISPLAY DEVICE PARTITION, PLASMA DISPLAY DEVICE, LIGHT EMISSION DISPLAY DEVICE, AND METHOD FOR MANUFACTURING LIGHT EMISSION DISPLAY DEVICE PARTITION

(76) Inventor: Iwao Ueno, Kyoto (JP)

(21) Appl. No.: 13/062,970

(22) PCT Filed: Nov. 9, 2009
(86) PCT No.: PCT/JP2009/005948

§ 371 Date: Mar. 9, 2011

(30) Foreign Application Priority Data
Nov. 10, 2008 (JP) 2008-287858

(51) Int. Cl. G09G 3/28; B05D 3/02

(52) U.S. Cl. 345/60; 427/380

(57) ABSTRACT

A light-emitting display device partition wall of the present invention contains at least one element selected from the group consisting of Mg, Ca, Ba, Sr, Y, La, Ce, Eu and Yb, and a concentration of the at least one element is higher on the surface side of the partition wall than on the inner portion side of the partition wall.

### TECHNICAL FIELD

The present invention relates to a light-emitting display device such as a plasma display device used for displaying images such as TVs, and a rear panel for use with the same.

### BACKGROUND ART

In recent years, the demand for high-definition, high-quality, large-screen TVs has been increasing. In addition to these characteristics, a plasma display device (referred to also as “Plasma Display Panel (PDP)”) is also thin and light. Therefore, plasma TVs using plasma display devices have been drawing public attention.

A plasma display device realizes full-color display by additive color mixture using so-called three primary colors. In order to realize the full-color display, a PDP includes fluorescence layers emitting light of different colors of red (R), green (G) and blue (B), which are the three primary colors, provided in partition walls. Fluorescence particles of the fluorescence layers are excited by the vacuum ultraviolet radiation caused by the Xe resonance line whose center wavelength is 147 nm and the molecular beam whose center wavelength is 172 nm which occur in the rear panel of the plasma display device, thus producing visible light of different colors of red, green and blue.

In the plasma display device, plasmas are confined in discharge cell ribs to generate ultraviolet radiation. Therefore, an important object for improving the characteristics is to generate larger amounts of ultraviolet radiation. Patent Document Nos. 1 and 2 disclose techniques in which a layer with getter function is provided on the partition wall of the rear panel of the discharge cell so that impurities in the discharge cell are removed efficiently, thereby increasing the discharge gas purity, thus increasing the amount of ultraviolet radiation caused by the discharge.

### Citation List

### Patent Literature

Patent Document No. 1: Japanese Patent No. 3467624

Patent Document No. 2: Japanese Laid-Open Patent Publication No. 2003-303555

### SUMMARY OF INVENTION

### Technical Problem

As high-definition TV broadcasting has become widespread, full-spec high-vision display devices whose number of pixels is 1920 (horizontal)×1080 (vertical) are in demand. As compared with a conventional NTSC display device whose number of pixels is 852 (horizontal)×480 (vertical), a full-spec high-vision display device has six times more pixels and 2.25 times more display electrodes and address electrodes. Therefore, the area of the light-emitting cell per inch of a full-spec high-vision plasma display device is very small at about ⅙ of that of the cell of a conventional NTSC display device, and the number of electrodes is also increased 2.25 times.

For reasons described above, it is necessary to increase the light-emitting efficiency of each cell in order to realize a full-spec high-vision plasma display device. Therefore, in conventional full-spec high-vision plasma display devices, the partition wall interval of cells is reduced so as to reduce the area of the partition wall which is a region that does not emit light. For example, in a 42-inch full-spec high-vision plasma display device, the size of one pixel is 0.48 mm, and the thickness of the partition wall dividing cells of different colors from one another is set to about 0.16 mm.

In order to prevent a decrease in the light-emitting efficiency due to the decrease in cell size, the concentration of the Xe gas which is a discharge gas is increased. For example, the Xe gas partial pressure in the Ne—Xe mixed gas is increased to be 15% or more.

However, where such a structure is employed, the discharge space is narrowed along with the cell miniaturization, and electrons generated by discharge easily drift toward the partition wall and disappear. Therefore, in order to obtain the same brightness as with a conventional panel, it is necessary to apply a higher discharge voltage. As a result, there is a new problem that the power consumption increases and the brightness efficiency decreases.

The technique disclosed in Patent Document Nos. 1 and 2 focuses on the removal of the impurity gas in the rear panel, and cannot sufficiently solve the above problem. Such a problem is not only of plasma display devices, but is common to light-emitting display devices, such as electric field emission type display devices, in which an image is displayed by confining discharge in a discharge cell formed by partition walls and using a fluorescence.

The present invention has been made in view of the problem above of the conventional technique, and has an object to provide a light-emitting display device partition wall, a plasma display device, a light-emitting display device and a method for manufacturing a light-emitting display device partition wall with desirable ultraviolet-light-emitting efficiency.

### Solution to Problem

A light-emitting display device partition wall of the present invention contains at least one element selected from the group consisting of Mg, Ca, Ba, Sr, Y, La, Ce, Eu and Yb, wherein a concentration of the at least one element is higher on a surface side of the partition wall than on an inner portion side of the partition wall.

In a preferred embodiment, a distribution of another element of the partition wall material, except for the at least one element, is substantially uniform throughout the partition wall.

In a preferred embodiment, the at least one element is diffused from a surface of the partition wall into an inner portion of the partition wall so that the concentration of the at least one element is higher on the surface side of the partition wall than on the inner portion side of the partition wall.

A plasma display device of the present invention includes: a front panel including a transparent substrate and a plurality of display electrodes provided in a stripe arrangement on the transparent substrate; and a rear panel including a support substrate, a plurality of address electrodes provided in a stripe arrangement on the support substrate, a plurality of partition walls provided on the support substrate so as to be located at least between the address electrodes, and a fluorescence layer arranged so as to cover the address electrodes between the partition walls, wherein: the front panel and the rear panel are arranged opposing each other so that the address electrodes and the display electrodes are generally perpendicular to each other, and discharge gas is sealed in a space between the partition walls; and the partition wall is any of the light-emitting display device partition walls set forth above.

In a preferred embodiment, a surface of the partition wall is in contact with the discharge gas.

In a preferred embodiment, the discharge gas contains 15% by volume or more of xenon gas.

A light-emitting display device of the present invention includes: an excitation source for emitting an electromagnetic wave or an electron beam having a shorter wavelength than visible light; and any of the light-emitting display device partition walls set forth above arranged at a position where the electromagnetic wave or the electron beam is emitted.

A method for manufacturing a light-emitting display device partition wall of the present invention includes the steps of: (A) preparing a partition wall; (B) immersing the partition wall into a solution containing a non-water-soluble organometallic compound including at least one element of Mg, Ca, Ba, Sr, Y, La, Ce, Eu and Yb and a nonaqueous solvent; (C) removing the nonaqueous solvent and obtaining the partition wall with the non-water-soluble organometallic compound attached to a surface thereof; and (D) performing a heat treatment on the partition wall with the non-water-soluble organometallic compound attached to the surface thereof.

In a preferred embodiment, the non-water-soluble organometallic compound is at least one selected from a metal salt of fatty acid, metal acetylacetate, non-saturated metal carboxylate, a metallocene compound, and β-diketone.

In a preferred embodiment, the step (D) heats the partition wall with the non-water-soluble organometallic compound attached to the surface thereof to 500° C. or more and 650° C. or less.

### Advantageous Effects of Invention

According to the present invention, the concentration of at least one element of Mg, Ca, Ba, Sr and Y, La, Ce, Eu and Yb is higher on the surface side of the partition wall than on the inner portion side of the partition wall. Since an oxide of the element is a high-γ material, the presence of the oxide of the element itself on the surface of the partition wall promotes the emission of secondary electrons, thus making it possible to supply many electrons during discharge from the surface of the partition wall. Thus, with the light-emitting display device partition wall of the present invention, the discharge voltage is lowered, and electrons generated by discharge do not drift toward the partition wall and disappear even if the partition wall interval is narrowed, but rather it is possible to increase the electrons and to improve the brightness.

Therefore, with the present invention, it is possible to obtain a high-definition plasma display device, e.g., full-spec high-vision, which is capable of preventing brightness deterioration while driving the panel with high definition, which is free from color non-uniformity and screen burn-in, and which has a long lifetime and a low power consumption.

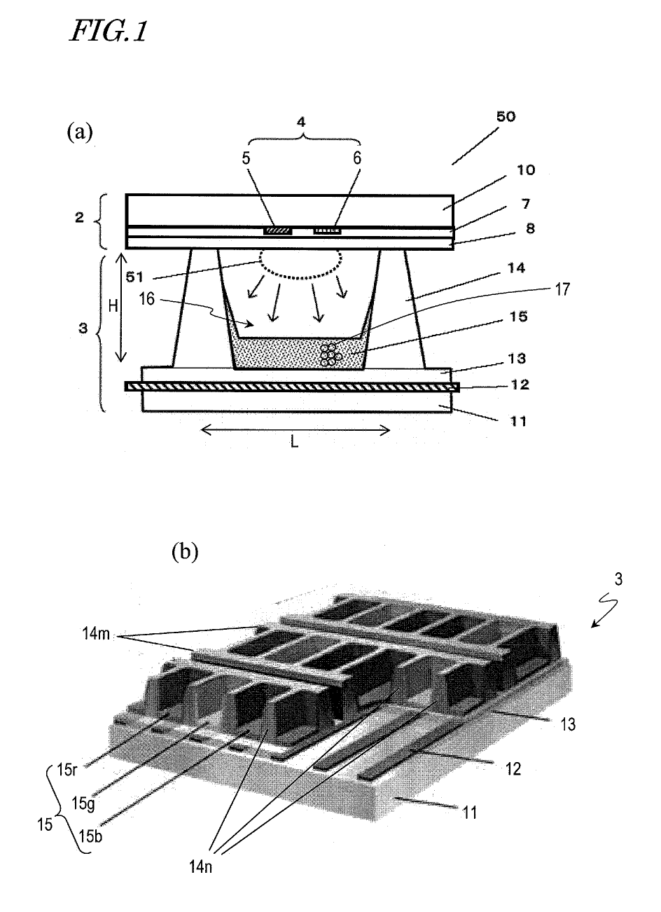

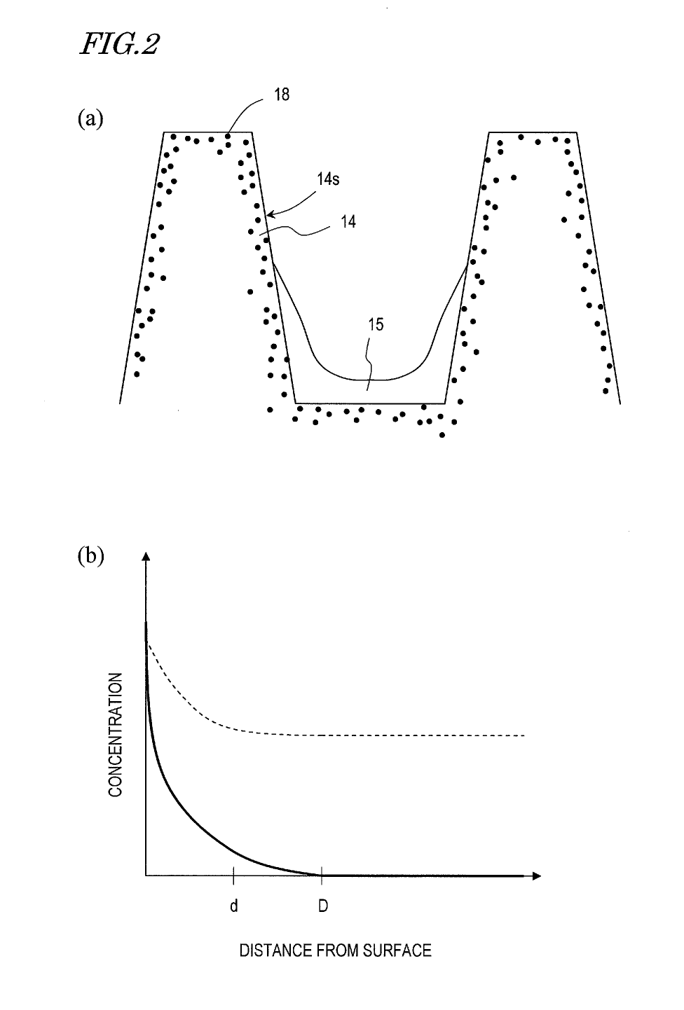

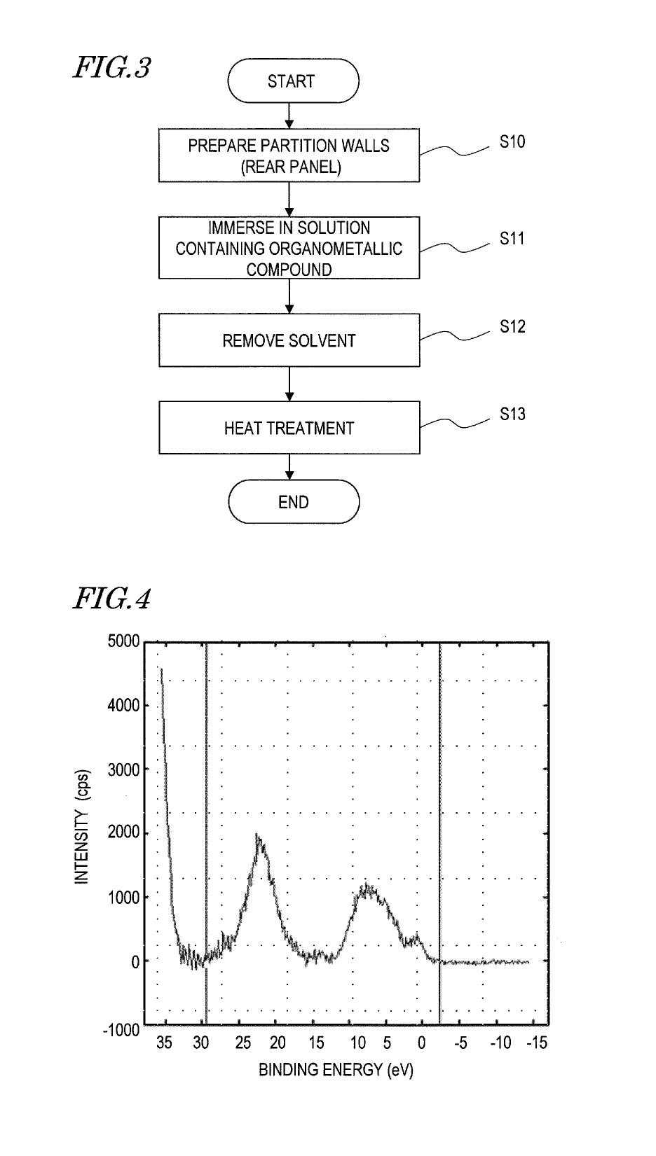

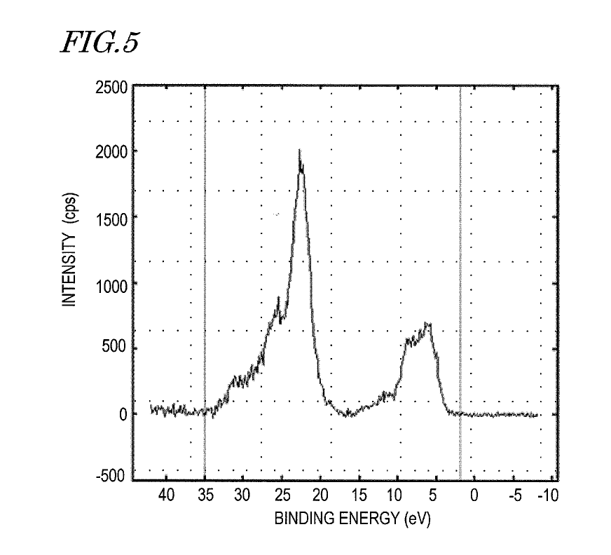

### BRIEF DESCRIPTION OF DRAWINGS

[FIG. 1](a) is a conceptual cross-sectional view showing a structure of a rear panel, which is an embodiment of a plasma display device of the present invention, and (b) is a partially-cross-sectional perspective view of the rear panel.

[FIG. 2](a) is a schematic cross-sectional view showing a structure of an embodiment of a partition wall according to the present invention, and (b) is a schematic graph showing the concentration distribution in the depth direction of a certain element in the vicinity of the partition wall surface.

[FIG. 3] A flow chart showing a method for manufacturing a partition wall according to the present invention.

[FIG. 4] XPS analysis results of an example of a partition wall according to the present invention.

[FIG. 5] XPS analysis results of a comparative example.

### DESCRIPTION OF EMBODIMENTS

In the conventional technique disclosed in Patent Document Nos. 1 and 2, the whole or part of the partition wall surface of the rear panel is covered with a protection layer made of MgO, Al₂O₃, or the like, and the impurity gas in the cell is absorbed by the getter effect, thereby improving the light-emitting efficiency. However, since such a protection layer is typically produced by vapor deposition or solid phase reaction, it is difficult to evenly coat the partition wall surface with irregularities, and in a case where the protection layer is thickly covering the partition wall surface, it may exfoliate during discharge.

In view of such a problem of the conventional technique, instead of coating the partition wall surface of the rear panel with a protection layer, or the like, the present invention adds a metal having a high secondary electron emission rate to the partition wall surface layer portion of the rear panel so as to increase the amount of distribution of a metal oxide having a high secondary electron emission rate in the vicinity of the surface layer of the partition wall, thus suppressing the disappearance of electrons in the partition wall surface layer.

An embodiment of the rear panel and the light-emitting display device of the present invention will now be described in detail. In the following embodiment, a plasma display device will be described in detail as an example of a light-emitting display device.

FIG. 1(a) is a cross-sectional view schematically showing a structure of a rear panel which is the unit of discharge of a surface-discharge AC plasma display device 50 which is an embodiment of the plasma display device according to the present invention. As shown in FIG. 1(a), the plasma display device 50 includes a front panel 2 and a rear panel 3.

The front panel 2 includes a transparent substrate 10, and a plurality of display electrodes 4 provided on the transparent substrate 10. The transparent substrate 10 preferably transmits visible light therethrough, and is formed by a glass substrate, for example. The display electrodes 4 include scan electrodes 5 and sustain electrodes 6 in a stripe arrangement, and are preferably formed by a transparent conductive material such as ITO. Although not shown, fine-line-patterned bus electrodes for reducing the electric resistance of these electrodes may be further formed on the scan electrode 5 and the sustain electrode 6. Preferably, a dielectric layer 7 is provided on the surface of the transparent substrate 10 so as to cover the display electrodes 4, and a protection layer 8 made of MgO, or the like, is further provided.

FIG. 1(b) is a partially-cross-sectional perspective view of the rear panel 3. As shown in FIGS. 1(a) and 1(b), the rear panel 3 includes a support substrate 11, a plurality of address electrodes (referred to also as “data electrodes”) 12 provided on the support substrate 11, partition walls 14, and a fluorescence layer 15 containing fluorescence particles 17. The support substrate 11 is formed by a glass substrate, or the like. The plurality of address electrodes 12 in a stripe arrangement are provided on the support substrate 11. A dielectric layer 13 may be provided on the support substrate 11 so as to cover the address electrodes 12. The dielectric layer 13 is made of a low-melting glass, or the like.

The partition walls 14 include a plurality of first partition walls 14n provided on the support substrate 11 so that they are located at least between the address electrodes 12. In the diagram shown in FIG. 1(a), the first partition walls 14n are not shown because they are arranged in parallel to the sheet of FIG. 1(a). More preferably, the partition walls 14 also include a plurality of second partition walls 14m arranged perpendicular to the address electrodes 12, and form a lattice structure (waffle rib structure) in which the periphery of the rear panel is surrounded by the first partition walls 14n and the second partition walls 14m. By employing the lattice structure, it is possible to prevent emitted light from leaking to adjacent cells.

The partition walls 14 and the space defined by the same form a discharge cell 16. On the rear panel 3, the discharge cells 16 are one-dimensionally arranged along each of the address electrodes 12. The height H of the partition walls 14 is about 120 μm. The interval L between the partition walls 14 is about 200 μm. The partition walls 14 will later be described in detail.

In each discharge cell 16 of the rear panel 3, the fluorescence layer 15 is provided above the address electrode 12 with the dielectric layer 13 therebetween. As shown in FIG. 1(b), preferably, fluorescence layers 15r, 15g and 15b emitting light of different colors of red (R), green (G) and blue (B) are arranged in three adjacent discharge cells, respectively, and the three discharge cells 16 together form a pixel.

As shown in FIG. 1(a), the front panel 2 and the rear panel 3 are arranged so that the display electrodes 4 and the address electrodes 12 run generally perpendicular to each other, and the partition walls 14 provided on the rear panel 3 are in contact with the protection layer 8 of the front panel 2, thereby sealing the space between the partition walls 14, i.e., the space of each discharge cell 16. Thus, in each discharge cell 16, the display electrode 4 and the address electrode 12 run perpendicular to each other while opposing each other.

The discharge cells 16 are charged with an Xe (xenon)-containing gas as the discharge gas. Preferably, it is charged with a rare gas mixture such as xenon/neon, xenon/helium or xenon/argon containing Xe at a proportion of 15% by volume or more and 100% by volume or less, with a pressure of about some tens of kPa.

The plasma display device 50 first applies a voltage between the address electrode 12 and the scan electrode 5 of the discharge cell 16 to be lit, thus causing address discharge. Thus, wall charge accumulates in the discharge cell 16. Then, as a voltage is applied between the sustain electrode 6 and the scan electrode 5, display discharge 51 occurs only in the discharge cell 16 where wall charge is accumulated by the address discharge. The display discharge 51 generates ultraviolet radiation through excitation of Xe in the sealed discharge gas. The generated ultraviolet radiation excites the fluorescence particles 17 of the fluorescence layer 15 to emit visible light of a predetermined color. Therefore, it is possible to arbitrarily select and light any of the plurality of discharge cells 16 arranged in a matrix pattern by selecting the address electrode 12 and the scan electrode 5.

Next, the structure of the partition wall 14 will be described in detail. FIG. 2(a) schematically shows the cross-sectional structure of the partition wall 14. As shown in FIG. 2(a), the partition wall 14 contains at least one element 18 of Mg, Ca, Ba, Sr, Y, La, Ce, Eu and Yb. FIG. 2(b) is a schematic concentration distribution graph showing the concentration of the element 18 from a surface 14s of the partition wall 14. As shown in FIGS. 2(a) and 2(b), the element 18 is present in a region in the vicinity of the surface of the partition wall 14, and the concentration of the element 18 is higher on the surface 14s side than on the inner portion side of the partition wall 14 with respect to the depth direction perpendicular to the surface 14s. It is believed that the element 18 is present as an oxide in the partition wall 14. It is only required that the element 18 is present at least in a region in the vicinity of the surface 14s of the partition wall 14 that is not covered by the fluorescence layer 15.

The entire partition wall 14 is made of ceramics or low-melting glass. Specifically, it is made of ceramics whose main component is SiO₂, Al₂O₃ or MgO to which Sr, Ba, Ca, Y, Ti, or the like, is added, or a low-melting glass whose main component is a CaO—MgO—Al₂O₃—SiO₂ type material to which Na, Ba, Sr, B, Bi, Y, Ti, or the like, is added. The element 18 may be one of the elements of the low-melting glass, or the element 18 may not be a constituent of the low-melting glass. In a case where the element 18 forms ceramics or low-melting glass, the element 18 is contained across the entire partition wall 14. However, as indicated by a dotted line in FIG. 2(b), the concentration of the element 18 is higher on the surface 14s side than on the inner portion side of the partition wall 14 in the region in the vicinity of the surface of the partition wall 14.

Such a concentration distribution of the element 18 is realized by diffusing the element 18 from the surface 14s of the partition wall 14 into the partition wall 14 as will later be described in detail. According to a research of the present inventor, in a case where the element 18 is diffused from the surface 14s of the partition wall 14 into the partition wall 14, the concentration of the element 18 in the depth direction has a distribution such that it is higher on the surface side 14s and monotonously decreases inward. The distance D by which the element 18 diffuses into the partition wall 14 depends on the material of the partition wall 14, the element 18, and conditions under which the element 18 is diffused. In a case where the partition wall 14 is formed by a material described above and the element 18 is diffused into the partition wall 14 by a method to be described below, the distance D by which the element 18 diffuses is about some nm to about some hundreds of nm. In the present invention, it is only required that the element 18 is diffused to a depth d of about 20 nm from the surface 14s and that the concentration of the element 18 is higher on the surface 14s side than on the inner portion side of the partition wall 14 over the extent from the surface 14s to the depth d. The distance D for which the element 18 is diffused may be shallower than the depth d above.

Note that in a case where a material such as low-melting glass forming the partition wall contains the element 18 but the element 18 is not diffused into the partition wall from the surface of the partition wall, the concentration of the element 18 is uniform in the depth direction of the partition wall. In such a case, the element 18 is present also in the vicinity of the surface of the partition wall. However, the concentration of the element 18 in such a case is dictated by the composition of the material such as low-melting glass, and it is typically lower than the concentration of the element 18 in the vicinity of the surface of the partition wall as compared with a case where the element 18 is diffused from the surface into the partition wall. Therefore, it is believed that it is not possible to sufficiently obtain the effect of the present invention from the element 18 as will be described below.

The distribution of other elements of the partition wall material, other than the element 18, in the depth direction is preferably substantially uniform. That is, the partition wall 14 is preferably formed by a substantially uniform composition except that the element 18 is diffused from the surface 14s. Here, substantially means that for example we ignore the slight oxidation of the uppermost surface of the partition wall 14 when the partition wall 14 is stored in the atmosphere, the detachment of part of the element of the partition wall when the partition wall 14 is placed in a plasma display device and exposed to a discharging environment, and the distribution of the constituent element which inevitably occurs when manufacturing the partition wall 14.

The distribution of the element 18 in the vicinity of the surface of the partition wall 14 can be detected by an analysis method capable of element analysis of an uppermost portion of a sample such as XPS (X-ray photoelectron spectroscopy). With methods such as XRD (X-ray diffraction), the content of the element across the entire sample is evaluated, and it is therefore difficult to detect the element in the vicinity of the surface. Since the element 18 is contained in the vicinity of the surface of the partition wall 14, it is usually difficult to quantitatively evaluate the element 18.

As described above, with conventional techniques, the partition wall is covered by a protection layer made of MgO, Al₂O₃, or the like. In such a case, the provision of the protection layer on the surface of the partition wall increases the volume of structural parts which do not contribute to discharge such as ribs and protection layers in the plasma display device and decreases the cell volume. As a result, if the cell size decreases due to an increase in the definition of the plasma display device, the cell volume further decreases, thus lowering the light emission intensity from each cell. In a case where the protection layer is provided on the surface of the partition wall, there may occur a problem that the protection layer easily exfoliates when ions impinge thereon.

In contrast, in the present invention, the element is captured inside the partition wall 14 and is in an oxidized state inside the ceramics or low-melting glass of the partition wall 14. Therefore, the oxide layer of the element 18 is not present on the surface 14s of the partition wall 14 to such an extent that it can be clearly observed by an analysis method such as XPS. In a case where the partition wall 14 is formed by ceramics, the element 18 is present in the form of an oxide more at the particle boundaries of the ceramics than in the particles thereof. Therefore, in the present invention, the cell volume does not decrease.

The oxide of Mg, Ca, Ba, Sr, Y, La, Ce, Eu and Yb, used as the element 18, is known to be a material having a high electron emission capacity (high-y material), and the presence of the oxide of the element 18 in the region in the vicinity of the surface of the partition wall 14 promotes the emission of the secondary electron and makes it possible to supply more electrons from the surface 14s of the partition wall 14 during discharge. Therefore, it is possible to decrease the discharge voltage. Since the discharge voltage decreases, the acceleration of ions during discharge is also weakened, and the magnitude of impact when ions impinge on the partition wall is also reduced. Therefore, it is possible to suppress deterioration of the partition wall due to ion impingement. Moreover, the element 18 having such a function is present from the surface to the inner portion of the partition wall 14, and therefore the element 18 hardly detaches from the partition wall 14 due to ion impingement during discharge.

Electrons are more easily emitted from the surface 14s of the partition wall 14, and the electrons emitted from the partition wall 14 spread across the entire surface 14s of the partition wall 14. As a result, even if the partition wall interval is narrowed, electrons generated by discharge do not drift toward the partition wall 14 and disappear, and it is rather possible to increase electrons. Therefore, the increase in electrons decreases the discharge voltage, and it is possible to efficiently excite Xe of an even higher concentration. It is believed that this increases the probabilities of occurrence of ultraviolet radiation at 147 nm and 172 nm, leading to a brightness improvement.

Such an effect is obtained as electrons which have permeated into the partition wall 14 impinge on the element 18 present in the vicinity of the surface 14s of the partition wall 14, and secondary electrons are emitted into the cell from the surface 14s of the partition wall 14, and therefore it is not necessary that the element 18 has diffused deep into the partition wall 14. This effect can be obtained if the element 18 is present at the depth d above from the surface 14s. In the present invention, as the element 18 is diffused from the surface 14s of the partition wall 14, the effect of the present invention is more easily obtained since the concentration of the element 18 is higher on the surface 14s side than on the inner portion side of the partition wall 14 even if the distance D for which the element 18 diffuses is short.

Therefore, with the present invention, it is possible to obtain a high-definition plasma display device, e.g., full-spec high-vision, which is capable of preventing brightness deterioration while driving the panel, which is free from color non-uniformity and screen burn-in, and which has a long lifetime and a low power consumption.

Next, a method for manufacturing the partition walls 14 and the plasma display device 50 will be described. First, referring to FIG. 3, a method for manufacturing the partition walls 14 will be described. As shown in FIG. 3, a rear panel made of low-melting glass is prepared (step S10).

Then, a solution containing a non-water-soluble organometallic compound including at least one element of Mg, Ca, Ba, Sr, Y, La, Ce, Eu and Yb is prepared, and the rear panel is immersed therein (step S11).

The non-water-soluble organometallic compound (organometallic complex) is preferably metal carboxylate such as saturated metal carboxylate, particularly a metal salt of saturated fatty acid (a metal salt of naphthenic acid, octanoic acid, stearic acid, lauric acid, caproic acid, etc.) and non-saturated metal carboxylate (a metal salt of methacrylic acid, acrylic acid, etc.), metal acetylacetate, metallocene compound, or β-diketone. These non-water-soluble organometallic compounds are nonaqueous solvents, i.e., they solve in organic solvents. An organic solvent is preferably a hydrocarbon such as butyl acetate, toluene, xylene and benzene.

For example, 2-ethyl-hexanoate Mg is used as the non-water-soluble organometallic compound, and it is solved in xylene, thus preparing a solution containing an organometallic compound. The concentration of the organometallic compound is 0.5 mol/L, for example.

To 1.0 part by weight of the partition wall, 0.05 to 5.0 parts by weight of the organometallic compound was added, and 1.0 to 5.0 parts by weight of a xylene solution was added as a diluent. The preferred amount of addition of the solution containing the organometallic compound was 0.05 parts by weight or more and less than 3.0 parts by weight.

No deterioration suppressing effect was seen with an amount of addition less than 0.05 parts by weight. When it was 3.0 parts by weight or more, the partition wall was coated by the oxide of the organometallic compound, thus decreasing the initial light emission intensity of the panel. The preferred range of the amount of addition was 0.05 parts by weight or more and 3.0 parts by weight or less.

After the partition wall is immersed for about 5 to 10 min in a solution containing an organometallic compound, an excessive portion of the solution is removed by natural separation, and it is dried by natural drying or by using an oven at a temperature of 120° C. or more and 180° C. or less to remove xylene or butyl acetate which is the organic solvent (step S12). Thus, it is possible to obtain a rear panel with an organometallic compound attached thereto.

Then, the rear panel is subjected to a heat treatment in the atmosphere at a temperature of 500° C. or more and 650° C. or less, and more preferably at a temperature of 520° C. or more and 600° C. or less (step S13). The retention time is preferably 10 min or more and 120 min or less. From the results of heat analysis, the organometallic compound starts to be decomposed at about 480° C. Shorter than 10 min, the diffusion of Mg, Ca, Ba, Sr or Y, La, Ce, Eu and Yb in the organometallic compound into the partition wall is not sufficient. Carbon, etc., may remain, and may possibly affect the initial characteristics and the life span characteristics. On the other hand, if the heating time is longer than 120 min, the brightness or the chromaticity easily changes due to oxidation of the partition wall. A more preferred retention time is 30 min or more and 60 min or less. Thus, it is possible to obtain the partition wall of the present embodiment. Other than in the atmosphere, the heat treatment may be performed under conditions where the oxygen partial pressure is controlled such as in nitrogen.

Thus, in the method for manufacturing the partition wall of the present invention, at least one of Mg, Ca, Ba, Sr, Y, La, Ce, Eu and Yb is used as the non-water-soluble organometallic compound, and is dissolved in an organic solvent to be attached or adsorbed onto the surface of the partition wall. The rear panel which is an inorganic oxide is immersed at room temperature in a solution obtained by mixing together an organometallic compound (organometallic complex) not containing water molecules or hydroxyl groups (—OH groups) and an organic solvent (nonaqueous solvent) not containing water molecules or hydroxyl groups (—OH groups). Thus, Mg, Ca, Ba, Sr, Y, La, Ce, Eu and Yb as it is in the form of an unoxidized, organometallic compound can be adsorbed onto the partition wall surface of the rear panel.

In this process, it is believed that since water molecules or hydroxyl groups (—OH groups) are not present in the mixed solution, the organometallic compound (organometallic complex) does not hydrolyze in the mixed solution but can be adsorbed onto the partition wall surface as it is (in the form of an organometallic compound).

By removing the organic solvent in the mixed solution and through drying in the atmosphere, it is possible to obtain the partition wall with the organometallic compound attached on the surface thereof. While the method for removing the organic solvent may be natural separation, the organometallic compound can be attached to the partition wall surface with a more uniform thickness if the organic solvent is removed through centrifugation, or the like.

Then, by heating the partition wall with the organometallic compound attached thereto in the atmosphere, the organometallic compound thermally decomposes on the partition wall surface so that the metal diffuses into the partition wall and a chemical reaction occurs with the low-melting glass material of the partition wall. In this process, while the temperature of the heat treatment of the partition wall with the organometallic compound attached thereto is in the range described above, since the thermal decomposition reaction of the organometallic compound is an exothermic reaction, it is assumed that the interface between the partition wall and the organometallic compound locally exceeds the heat treatment temperature. Therefore, it is believed that the metal element component of the organometallic compound diffuses into the lattice of the low-melting material, and it can be coupled with oxygen while maintaining the properties as a low-melting material, thus producing regions where the concentration of the diffused element is high.

With a conventional method in which a protection film is formed on the partition wall surface by dispersing or dissolving it in pure water or aqueous alcohol solution, the organometallic compound hydrolyzes while it is dispersed or dissolved in pure water or aqueous alcohol solution, and the metal hydroxide is attached to the partition wall surface. When a hydroxide is attached, dehydration reaction occurs in the next heat treatment step, and the reaction at the interface between the partition wall and the attached hydroxide is an endothermic reaction, thus effectively lowering the temperature, so that the attached hydroxide is unlikely to diffuse into the lattice of partition walls. Therefore, with the conventional method, it is believed that a metal oxide film is formed only to cover the partition wall surface and the metal is unlikely to diffuse into the partition wall. It is believed that the dehydration reaction does not progress sufficiently, and metal hydroxide or metal carbonate forms a relatively thick layer, as it is, on the surface of the partition wall.

For such reasons, in a case where at least one of Mg, Ca, Ba, Sr, Y, La, Ce, Eu and Yb is diffused into the partition wall by the method described above, it is preferred that these metals are not present, in the form of an oxide, on the partition wall surface. However, even if an oxide of such a material segregates at the triple point, or the like, of the partition wall material due to the manufacturing process, it is not particularly a problem if it is to such a degree that the reflection efficiency of the partition wall does not change significantly.

Note however that an oxide of an alkaline earth metal such as Mg, Ca, Ba or Sr is likely to be altered in the atmosphere to be hydroxide or carbonate. Therefore, it is preferred that partition walls produced by the method described above are stored in an inert atmosphere, etc., because an oxide described above may possibly be segregated on the surface.

Next, a method for manufacturing the plasma display device 50 will be described with reference to FIGS. 1(a) and 1(b).

### 1. Production of Rear Panel 3

First, the address electrodes 12 having a thickness of some μm, for example, and formed in a stripe arrangement, are formed on the surface of the support substrate 11 made of a glass substrate. A metal such as Ag, Al, Cr (chromium), Cu (copper), Pd (palladium), or the like, a combination thereof, or a layered electrode formed by layering layers of these metals may be used as necessary as the electrode material.

Then, the dielectric layer 13 is formed on the support substrate 11 so as to cover the address electrode 12. The dielectric layer 13 can be formed by a lead or lead-free low-melting glass, SiO₂, etc.

Then, the partition walls 14 are formed on the dielectric layer 13. After a low-melting glass material paste is applied across the entire surface of the dielectric layer 13 and baked, a lattice pattern including the partition walls 14n parallel to the address electrodes 12 and the partition walls 14m vertical to the address electrodes 12 as shown in FIG. 1(b) is formed by a sandblast method, a photolithography method, etc. Adjacent discharge cells are partitioned from one another by the partition walls 14. The interval between the partition walls 14 is 200 μm, for example.

Then, the fluorescence layer 15 is formed at least in a portion of each discharge cell 16 partitioned by the partition walls 14 above the address electrode 12. The fluorescence layer 15 is formed by applying through a printing process a paste made of fluorescence particles of each fluorescence color, a vehicle, etc., and baking it. For example, (Y,Gd)BO₃:Eu, (Y,Gd)BO₃:Tb and BaMgAl₁₀O₁₇:Eu are used as fluorescence materials of three colors of red, green and blue. Fluorescence materials having compositions for AC plasma display devices may be used.

Then, an organometallic compound including Mg, Ca, Ba, Sr, Y, La, Ce, Eu and Yb is attached to the partition wall surface of the rear panel and a heat treatment is performed, thereby decomposing the organometallic compound and diffusing Mg, Ca, Ba, Sr, Y, La, Ce, Eu and Yb into the partition wall 14, as described above. These steps may be performed before the formation of the fluorescence layer 15. Alternatively, an organometallic compound including Mg, Ca, Ba, Sr, Y, La, Ce, Eu and Yb may be attached to the partition wall surface of the rear panel before or after the application of the paste to be the fluorescence layer 15, and the baking of the paste to be the fluorescence layer 15, the decomposition of the organometallic compound and the diffusion of Mg, Ca, Ba, Sr, Y, La, Ce, Eu and Yb into the partition wall 14 may be done through the same heat treatment. Thus, the rear panel 3 is completed.

### 2. Production of Front Panel 2

As shown in FIG. 1(a), the scan electrodes 5 and the sustain electrodes 6 in a stripe arrangement are formed on the transparent substrate 10 made of a glass substrate. Specifically, the scan electrodes 5 and the sustain electrodes 6 which have a relatively low resistance and are transparent and which are made of ITO, SnO₂, ZnO, etc., having a thickness of about 100 nm, for example, are formed on the transparent substrate 10. Although not shown, fine-line-patterned bus electrodes having a thickness of some μm, for example, are preferably formed on the scan electrodes 5 and the sustain electrodes 6 from an Ag (silver) or Al (aluminum) electrode material in order to lower the electric resistance of the scan electrodes 5 and the sustain electrodes 6.

Then, the dielectric layer 7 is formed on the transparent substrate 10 so as to cover the scan electrodes 5 and the sustain electrodes 6. The dielectric layer 7 is made of lead or lead-free low-melting glass or SiO₂, etc., and has a thickness of some μm to some tens of μm. The protection film 8 having a thickness of about 500 nm is formed on the dielectric layer 7 by a metal oxide material such as MgO (magnesium oxide), for example, which has a large secondary electron emission coefficient γ for lowering the discharge start voltage and a high sputtering resistance so that the dielectric layer 7 can be protected from ion impact during discharge, and which is optically transparent and highly electrically insulative. Thus, the front panel 2 is formed.

### 3. Assembly of Plasma Display Device 50 by Attaching Panels Together

The front panel 2 and the rear panel 3 produced as described above are aligned with each other so that the display electrodes 4 of the front panel and the address electrodes 12 of the rear panel are perpendicular to each other, and a sealing glass is inserted therebetween along the periphery of the panel. This is baked at about 450° C. for 10 to 20 min, for example, and evacuated to a high vacuum (e.g., 1.1×10⁻⁴ Pa), after which it is charged with a discharge gas (e.g., an He—Xe, Ne—Xe, Ar—Xe or Kr—Xe inert gas whose Xe partial pressure is 15% or more) with a predetermined pressure. Thus, a plasma display device is completed.

### EXAMPLES

Partition walls and plasma display devices of the present invention were produced and the characteristics thereof were evaluated, the results of which will now be described.

### Example 1

First, partition walls were produced using organometallic compounds shown in Table 1 according to the method described above. Xylene was used as the solvent for dissolving the organometallic compound, and adjustments were made in advance so that the concentration of the organometallic compound was 0.1 mol/L.

Then, in a glass container, the rear panel was immersed in the solution for about 10 min. Then, the rear panel was taken out, and the excess solution was separated. Then, the rear panel was dried by holding it in the air at about 150° C. for one hour, after which a heat treatment was performed in the atmosphere at about 600° C. for 10 min. Hereinafter, this step will be referred to as the organometallic treatment of partition walls.

TABLE 1

| | | | | Discharge | |
|---|---|---|---|---|---|
| Sample | Organometallic | Metal | Carbon | voltage | |
| No. | compound | number | number | (V) | Remarks |
| A1 | Mg naphthenate | 1 | 14 | 180 | |
| A2* | Zn naphthenate | 1 | 14 | 241 | |
| A3 | Ca naphthenate | 1 | 14 | 189 | |
| A4* | Mn naphthenate | 1 | 14 | 244 | |
| A5* | Mn octanoate | 1 | 16 | 243 | |
| A6* | Zn octanoate | 1 | 16 | 246 | |
| A7 | Ca octanoate | 1 | 16 | 182 | |
| A8 | Ba octanoate | 1 | 16 | 177 | |
| A9 | Y octanoate | 1 | 24 | 179 | |
| A10* | Ni octanoate | 1 | 24 | 246 | |
| A11 | Mg octanoate | 1 | 24 | 181 | |
| A12 | Mg stearate | 1 | 36 | 185 | |
| A13 | Ca stearate | 1 | 36 | 186 | |
| A14* | Zn stearate | 1 | 36 | 241 | |
| A15 | Ba stearate | 1 | 36 | 181 | |
| A16 | Sr stearate | 1 | 36 | 181 | |
| A17* | Mn stearate | 1 | 36 | 246 | |
| A18 | Ba laurate | 1 | 24 | 183 | |
| A19 | Sr laurate | 1 | 24 | 187 | |
| A20* | Zn laurate | 1 | 24 | 242 | |
| A21* | Mg ethoxide | 1 | 4 | 231 | aggregation |
| A22* | Mg oxalate | 1 | 2 | 232 | aggregation |
| A23* | none | 1 | 0 | 230 | |

*Comparative Examples (A2, A4-A6, A10, A14, A17, A20-A23)

First, in order to examine the state in which the metal in the organic metal is present in the produced partition wall, the element in the partition wall of Sample A11 treated with Mg octanoate was analyzed by X-ray photoelectron spectroscopy (XPS or ESCA). XPS can evaluate the oxidation state of atoms in the vicinity of the surface of a solid matter.

FIG. 4 shows the XPS analysis results of Sample A11. FIG. 5 shows XPS analysis results of a sample of a partition wall with a film made of MgO formed on the surface thereof by a sputtering method, which has been subjected to a heat treatment at about 600° C. for 10 min. They both show the spectrum of O2s. As is clear from the comparison between FIGS. 4 and 5, since the XPS of oxygen of Sample A11 is different from the XPS of oxygen of magnesium oxide provided in the partition wall surface, it can be seen that substantially no oxygen is present in the form of magnesium oxide in the surface of the partition wall of Sample A11.

That is, it can be seen that the partition wall of Sample A11 does not have such a structure as that of a partition wall with a protection layer made of MgO formed thereon by a conventional sputtering method, and Mg used in the organometallic treatment is present in an oxidized state different from MgO from the surface to the inner portion of the partition wall.

Samples treated with organometallic compounds of which the metal element is Mg (Samples A1, A11, A12), Ba (Samples A8, A15, A18), Sr (Samples A16, A19), Ca (Samples A3, A7, A13) and Y (Sample A9) among various organometallic compounds shown in Table 1 had a decrease in the discharge voltage as compared with Sample A23. It is believed that in these samples, the disappearance of secondary electrons was suppressed and the discharge efficiency was increased, thereby lowering the discharge voltage.

In contrast, there was a tendency that samples treated with organometallic compounds of which the metal element is Ni (Sample A10), Zn (Samples A2, A6, A14) and Mn (Samples A4, A5, A17) had a discharge voltage similar to or increased from that of Sample A23.

It has been seen from these results that it is preferred that organometallic compounds including Mg, Ca, Ba, Sr and Y are used as organometallic compounds, these metals are diffused into the partition walls, and oxides of these metals are placed in the vicinity of the surface of the partition walls. The oxides of La, Ce, Eu and Yb, which are rare-earth elements, as is Y, are known to be high-γ materials. Therefore, it is believed that it is possible to lower the discharge voltage by using organometallic compounds of these elements and diffusing these elements from the surface into the inner portion of partition walls.

With Samples A21 and A22, the hydrolysis of the organometallic compound progressed rapidly, and it was difficult to obtain samples that could be evaluated. It is believed that these samples are likely to hydrolyze because the carbon number is small and thus the organometallic compound is unstable in the air. Therefore, it is believed that even with organometallic compounds including Mg, Ca, Ba, Sr and Y, La, Ce, Eu and Yb, the organometallic compounds are likely to hydrolyze when organometallic compounds whose carbon number is 2 to 12 are used.

Note however that Sample A1 did not hydrolyze and it was possible to produce a sample, and it is therefore believed that there are some organometallic compounds that are stable even if the carbon number is about 14 depending on the structure of the organic compound. From the above, it is believed that it is preferred to use an organometallic compound whose carbon number is at least 14 or more. It is believed that even if the carbon number is 36 (Sample A12, etc.), the organometallic compound uniformly attached to the partition wall surface in a stable state and uniformly diffused into the partition walls through the heat treatment, thus increasing the discharge efficiency and lowering the discharge voltage. However, it is believed that if the carbon chain is excessively long, the carbon chain is unlikely to be decomposed during the heat treatment, and the metal is unlikely to diffuse into the partition walls. Therefore, it is assumed that a preferred carbon number for a metal number of 1 is in the range of about 14 to about 30.

From the results above, it has been seen that it is possible to lower the discharge voltage of the panel by attaching the non-water-soluble organometallic compound on the surface of the rear panel and performing the heat treatment to diffuse the metal into the partition walls. While the concentration of the solution used in the present example was 0.1 mol/L, effects were observed also with 0.05 mol/L. Note however that when the concentration of the non-water-soluble organometallic compound exceeded 1.0 mol/L, non-uniformity and exfoliation easily occurred during the manufacturing process, thus making the handling difficult.

From these results, it can be expected that the partition walls subjected to the organometallic treatment have stronger ionic bonds between lattices of the partition walls and generate more electrons and ions, thus providing effects such as leading to a decrease in the discharge voltage. It was also found that the constituent element of the organic metal diffuses into the lattice rather than physically depositing on the surface of the partition walls as is a coating film.

### Example 2

A plasma display device using partition walls of the present invention was produced, and the characteristics thereof were evaluated.

First, partition walls were produced using organometallic compounds shown in Table 2 according to the method described above. Commercially-available RGB materials were used as fluorescence materials. Xylene was used as the solvent for dissolving the organometallic compound, and adjustments were made in advance so that the concentration of the organometallic compound was 0.1 mol/L.

TABLE 2

| | Organometallic | | | Evaluation | |
|---|---|---|---|---|---|
| | compound | | | Discharge | |
| Sample | Organometallic | Metal | Carbon | voltage | Brightness |
| No. | compound | number | number | (V) | (cd/cm²) |
| B1 | Mg octanoate | 1 | 24 | 172 | 1406 |
| B2 | Ca octanoate | 1 | 16 | 182 | 1376 |
| B3 | Ba octanoate | 1 | 16 | 177 | 1398 |
| B4 | Y octanoate | 1 | 24 | 179 | 1392 |
| B5 | Mg octanoate | 1 | 24 | 181 | 1395 |
| B6 | Mg naphthenate | 1 | 14 | 180 | 1381 |
| B7 | Y stearate | 1 | 54 | 185 | 1393 |
| B8 | Ba stearate | 1 | 36 | 181 | 1316 |
| B9 | Sr stearate | 1 | 36 | 181 | 1375 |
| B10 | Ba laurate | 1 | 24 | 183 | 1234 |
| B11 | Sr laurate | 1 | 24 | 187 | 1308 |
| B12* | Y ethoxide | 1 | 6 | 229 | 652 |
| B13* | Ca butoxide | 1 | 8 | 235 | 666 |
| B14* | Ba butoxide | 1 | 8 | 230 | 668 |
| B15* | Sr ethoxide | 1 | 4 | 231 | 648 |
| B16* | Mg ethoxide | 1 | 4 | 231 | 681 |
| B17* | Mg oxalate | 1 | 2 | 232 | 644 |
| B18* | none | | 0 | 230 | 637 |

*Comparative Examples (No. B12-B18)

As in Example 1, in a glass container, the rear panel was immersed in the solution for about 10 min. Then, it was taken out, and the excess solution was separated. Then, the rear panel was dried by holding it in the air at about 150° C. for one hour, after which a heat treatment was performed in the atmosphere at about 600° C. for 10 min.

Using the partition walls produced as described above, a plasma display device was produced according to the method described above. Samples B1 to B11 of this example and Samples B12 to B18 of the comparative example have a number of pixels of 1920 (horizontal)×1080 (vertical) and thus have 50-inch full-spec high-vision specifications. One cell pitch (one partition wall pitch) was set to 0.20 mm (horizontal). The samples were evaluated as follows.

The discharge voltage (the voltage at which the panel is lit uniformly across the entire surface thereof when the applied voltage to the panel is increased) was measured for samples (B1 to B11) subjected to the organometallic treatment, a sample (B18) not subjected to the organometallic treatment, and samples (B12-B18) which were hydrolyzed using alkoxide of Mg, Ca, Ba, Sr and Y and in which the surface of the partition wall was coated with oxide.

Then, the discharge voltage and the brightness of each sample were measured by driving the sample with an optimal driving voltage of 170 to 240 V at 100 KHz and under conditions for a totally white image.

As shown in Table 2, Samples B1 to B11 subjected to the organometallic treatment have lower discharge voltages and higher brightnesses as compared with Sample B18 not subjected to the organometallic treatment and Samples B12 to B17 of the comparative example which were hydrolyzed using metal alkoxide. It is believed that this is because as the carbon number for a metal number of 1 is larger, an organometallic compound is more stable in the air and less likely to be hydrolyzed so that the metal more easily diffuses into the partition walls without forming oxide. However, it is believed that if the carbon chain is excessively long, the carbon chain is unlikely to be decomposed during the heat treatment, and the metal is unlikely to diffuse. Therefore, it is assumed that it is preferred that the carbon number for a metal number of 1 is in the range of 14 to 30. Thus, by diffusing at least one element from Mg, Ca, Ba, Sr and Y from the surface of the partition wall, defects and ion defects in the vicinity of the partition wall surface are recovered, and it is therefore possible to control the brightness improvement. These metals diffused are ionically bonded to oxygen in the partition wall and easily discharge electrons. Thus, the brightness improves, and it is possible to lower the discharge voltage.

The oxides of La, Ce, Eu and Yb, which are rare-earth elements, as is Y, are known to be high-γ materials. Therefore, it is believed that it is possible to lower the discharge voltage by using organometallic compounds of these elements and diffusing these elements from the surface into the inner portion of partition walls.

From these results, also when a plasma display device using partition walls of the present invention is produced, it is possible to suppress electrons generated by discharge from drifting toward the partition wall and disappearing by attaching the non-water-soluble organometallic compound to the partition wall surface and performing the heat treatment to diffuse the metal into the partition walls. It is also possible to increase the amount of electrons to be discharged. This lowers the discharge voltage and efficiently excites a high concentration of Xe, thus increasing the occurrence probability of ultraviolet radiation at 147 nm and 172 nm, leading to brightness improvement. Therefore, the discharge voltage of the panel in the plasma display device is lowered, and the brightness improves. It can also be said that the ionic bond of the lattice in the partition wall becomes stronger, and the ion impact resistance improves.

As described above, according to the present invention, at least one element selected from Mg, Ca, Ba, Sr, Y, La, Ce, Eu and Yb is diffused from the surface into the inner portion of the partition walls so that since oxides of these elements are high-γ materials, it is possible to promote the emission of secondary electrons and to supply more electrons during discharge from the surface of the partition walls. Thus, characteristics are exhibited that are not obtained with conventional partition walls which are obtained by physically coating the partition wall surface with metal oxide in an aqueous solution or an alcohol solution.

### INDUSTRIAL APPLICABILITY

With the partition wall of the present invention, the deterioration of the partition wall is suppressed, and it is possible to achieve a decrease in the discharge voltage and a high brightness. The partition wall can suitably be used in various plasma display devices and electric field emission type displays.

With a plasma display device of the present invention, since the discharge voltage is lowered and the brightness is improved, thus preventing brightness deterioration, it is therefore suitably used as a high-definition, low-power-consumption plasma display device.

The partition wall of the present invention can suitably be used also in various light emitting devices.

### REFERENCE SIGNS LIST

2 Front panel

3 Rear panel

4 Display electrode

5 Scan electrode

6 Sustain electrode

7 Dielectric layer

8 Protection layer

10 Transparent substrate

11 Support substrate

12 Address electrode

13 Dielectric layer

14 Partition wall

14s Surface

15 Fluorescence layer

16 Rear panel

17 Fluorescence particles

18 Diffused element

50 Plasma display device

51 Display discharge

D Depth (distance) from surface 14s

H Height of partition wall 14

L Interval between partition walls 14

S10 Step of preparing partition walls

S11 Step of immersing partition walls in solution containing organometallic compound

S12 Step of removing organic solvent

S13 Step of performing heat treatment

1. A light-emitting display device partition wall having diffused therein at least one element selected from the group consisting of Mg, Ca, Ba, Sr, Y, La, Ce, Eu and Yb, wherein
the light-emitting display device partition wall includes a region that is in a vicinity inside from a surface of the partition wall, a concentration of the at least one element being higher in the region than at the surface of the partition wall.

2. The light-emitting display device partition wall according to claim 1, wherein a distribution of another element of the partition wall material, except for the at least one element, is substantially uniform throughout the partition wall.

3. (canceled)

4. A plasma display device, comprising:
a front panel including a transparent substrate and a plurality of display electrodes provided in a stripe arrangement on the transparent substrate; and
a rear panel including a support substrate, a plurality of address electrodes provided in a stripe arrangement on the support substrate, a plurality of partition walls provided on the support substrate so as to be located at least between the address electrodes, and a fluorescence layer arranged so as to cover the address electrodes between the partition walls, wherein:
the front panel and the rear panel are arranged opposing each other so that the address electrodes and the display electrodes are generally perpendicular to each other, and discharge gas is sealed in a space between the partition walls; and
the partition wall is the light-emitting display device partition wall according to claim 1.

5. The plasma display device according to claim 4, wherein a surface of the partition wall is in contact with the discharge gas.

6. The plasma display device according to claim 4, wherein the discharge gas contains 15% by volume or more of xenon gas.

7. A light-emitting display device, comprising:
an excitation source for emitting an electromagnetic wave or an electron beam having a shorter wavelength than visible light; and
the light-emitting display device partition wall according to claim 1 arranged at a position where the electromagnetic wave or the electron beam is emitted.

8. A method for manufacturing a light-emitting display device partition wall, comprising the steps of:
(A) preparing a partition wall;
(B) immersing the partition wall into a solution containing a non-water-soluble organometallic compound including at least one element of Mg, Ca, Ba, Sr, Y, La, Ce, Eu and Yb and a nonaqueous solvent;
(C) removing the nonaqueous solvent and obtaining the partition wall with the non-water-soluble organometallic compound attached to a surface thereof; and
(D) performing a heat treatment on the partition wall with the non-water-soluble organometallic compound attached to the surface thereof to form a region that is in a vicinity inside from a surface of the partition wall, a concentration of the at least one element being higher in the region than at the surface of the partition wall.

9. The method for manufacturing a light-emitting display device partition wall according to claim 8, wherein the non-water-soluble organometallic compound is at least one selected from a metal salt of fatty acid, metal acetylacetate, non-saturated metal carboxylate, a metallocene compound, and β-diketone.

10. The method for manufacturing a light-emitting display device partition wall according to claim 8, wherein the step (D) heats the partition wall with the non-water-soluble organometallic compound attached to the surface thereof to 500° C. or more and 650° C. or less.
